(19) United States
(12) Patent Application Publication
(10) Pub. No.: US 2026/0072422 A1
(43) Pub. Date: Mar. 12, 2026

(54) SYSTEM, INFORMATION PROCESSING APPARATUS, INFORMATION PROCESSING METHOD, AND RECORDING MEDIUM

(71) Applicant: CANON KABUSHIKI KAISHA, Tokyo (JP)

(72) Inventor: TAKUJI OISHI, Kanagawa (JP)

(21) Appl. No.: 19/317,613

(22) Filed: Sep. 3, 2025

(30) Foreign Application Priority Data
Sep. 6, 2024 (JP) 2024-153985
Jul. 25, 2025 (JP) 2025-125206

(51) Int. Cl. G05B 19/418

(52) U.S. Cl. CPC G05B 19/41875; G05B 2219/32368

(57) ABSTRACT

An information processing apparatus receives input of a search condition and executes a determination process of determining a manufacturing condition for a sample in each of a plurality of search cycles. A trial manufacturing apparatus, in each of the plurality of search cycles, executes a manufacturing process of manufacturing the sample under the manufacturing condition determined in the determination process, and executes an evaluation process of evaluating the sample manufactured in the manufacturing process and outputting an evaluation result. The information processing apparatus, in the determination process in a first search cycle, determines the manufacturing condition in the first search cycle by using the search condition and a data set including data obtained in a second search cycle and a search cycle executed before the second search cycle. The information processing apparatus changes the search condition for a third search cycle and a search cycle after the third search cycle.

### BACKGROUND

### Field of the Technology

The present disclosure relates to a system, an information processing apparatus, an information processing method, and a recording medium.

### Description of the Related Art

In development of a material or the like, a raw material is selected, a mixing amount of the raw material is determined, a process such as stirring or heating of the material is performed, and thus a sample is manufactured. In addition, in the development, the manufactured sample is evaluated to obtain an evaluation value of the sample. A manufacturing condition of the sample is searched for such that this evaluation value satisfies a goal. In development like this, data-driven development focused on improving the performance of the material or improve the development efficiency is known. In the data-driven development, a manufacturing condition with which a desired evaluation value can be obtained is obtained from a data set including manufacturing conditions and evaluation values of the sample. Specifically, a manufacturing condition of the sample is determined, the sample is manufactured in accordance with the manufacturing condition, and an evaluation value is obtained by evaluating the manufactured sample. Then, by analyzing a data set including manufacturing conditions of the sample and evaluation values that have been obtained thus far, the manufacturing condition for the next sample is determined. These series of operations will be referred to as a search cycle, and a manufacturing condition with which a desired evaluation value can be obtained is obtained by repeatedly executing the search cycle.

A data analysis technique such as Bayesian optimization is often used for determining the manufacturing condition of the sample, and manufacture and evaluation of the sample are often performed manually.

Japanese Patent Application Laid-Open No. 2023-86450 discloses automating a series of search cycles by automatically performing the manufacture and evaluation of the sample by using a robot or the like.

The search condition for operating the series of search cycles, for example, the number of repetitions, the search range for the manufacturing condition of the sample, or the goal for the evaluation value is set by a user at first. However, in the case where the setting of the search condition is not appropriate, sometimes the amount of improvement in the evaluation value of the sample per search cycle becomes small, and the efficiency of the search is low.

### SUMMARY

The present disclosure provides a technique advantageous for performing the search more effectively.

According to a first aspect of the present disclosure, a system includes a trial manufacturing apparatus and an information processing apparatus and configured to execute a plurality of search cycles. The information processing apparatus is configured to receive input of a search condition and execute a determination process of determining a manufacturing condition for a sample in each of the plurality of search cycles. The trial manufacturing apparatus is configured to, in each of the plurality of search cycles, execute a manufacturing process of manufacturing the sample in accordance with the manufacturing condition determined in the determination process, and execute an evaluation process of evaluating the sample manufactured in the manufacturing process and outputting an evaluation result. The information processing apparatus is configured to, in the determination process in a first search cycle among the plurality of search cycles, determine the manufacturing condition for the manufacturing process in the first search cycle by using the search condition and a data set including data obtained in a second search cycle and a search cycle executed before the second search cycle among the plurality of search cycles, the second search cycle being earlier than the first search cycle in an execution order. The information processing apparatus is configured to change the search condition for a third search cycle and a search cycle after the third search cycle among the plurality of search cycles, the third search cycle being next to the first search cycle in the execution order.

According to a second aspect of the present disclosure, an information processing apparatus configured to execute a plurality of search cycles together with a trial manufacturing apparatus. The information processing apparatus configured to receive input of a search condition. The information processing apparatus configured to execute a determination process of determining a manufacturing condition of a sample in each of the plurality of search cycles. The information processing apparatus configured to cause the trial manufacturing apparatus to, in each of the plurality of search cycles, execute a manufacturing process of manufacturing the sample in accordance with the manufacturing condition, and an evaluation process of evaluating the manufactured sample and outputting an evaluation result. The information processing apparatus configured to determine, in the determination process in a first search cycle among the plurality of search cycles, the manufacturing condition for the manufacturing process in the first search cycle by using the search condition and a data set including data obtained in a second search cycle and a search cycle executed before the second search cycle among the plurality of search cycles, the second search cycle being earlier than the first search cycle in an execution order. The information processing apparatus configured to change the search condition for a third search cycle and a search cycle after the third search cycle among the plurality of search cycles, the third search cycle being next to the first search cycle in the execution order.

According to a third aspect of the present disclosure, an information processing method for an information processing apparatus configured to execute a plurality of search cycles together with a trial manufacturing apparatus. The information processing method includes receiving input of a search condition. The information processing method includes executing a determination process of determining a manufacturing condition of a sample in each of the plurality of search cycles. The information processing method includes causing the trial manufacturing apparatus to, in each of the plurality of search cycles, execute a manufacturing process of manufacturing the sample in accordance with the manufacturing condition, and an evaluation process of evaluating the manufactured sample and outputting an evaluation result. The information processing method includes determining, in the determination process in a first search cycle among the plurality of search cycles, the manufacturing condition for the manufacturing process in the first search cycle by using the search condition and a data set including data obtained in a second search cycle and a search cycle executed before the second search cycle among the plurality of search cycles, the second search cycle being earlier than the first search cycle in an execution order. The information processing method includes change the search condition for a third search cycle and a search cycle after the third search cycle among the plurality of search cycles, the third search cycle being next to the first search cycle in the execution order.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a manufacturing evaluation system according to a first embodiment.

FIG. 2A is an explanatory diagram of part of a search condition according to the first embodiment.

FIG. 2B is an explanatory diagram of part of the search condition according to the first embodiment.

FIG. 2C is an explanatory diagram of part of the search condition according to the first embodiment.

FIG. 3 is a flowchart of processing of the manufacturing evaluation system according to the first embodiment.

FIG. 4 is an explanatory diagram of an example of a search status according to the first embodiment.

FIG. 5 is an explanatory diagram of an example of the search status according to the first embodiment.

FIG. 6 is an explanatory diagram of an example of the search status according to the first embodiment.

FIG. 7 is an explanatory diagram of an example of the search status according to the first embodiment.

FIG. 8 is a flowchart of processing of a manufacturing evaluation system according to a second embodiment.

FIG. 9 is an explanatory diagram of a search status according to Example 1.

FIG. 10A is a diagram illustrating a search condition according to Example 2.

FIG. 10B is a diagram illustrating evaluation value parameters according to Example 2

FIG. 11A is a diagram illustrating an estimation accuracy of a model according to Example 2.

FIG. 11B is a diagram illustrating an estimation accuracy of the model according to Example 2.

FIG. 12 is a diagram illustrating a relationship between a processing time and the number of chipping according to Example 2.

### DESCRIPTION OF THE EMBODIMENTS

Exemplary embodiments of the present disclosure will be described in detail below with reference to drawings. Following embodiments are merely examples, and for example, details of the configurations thereof can be appropriately modified by one skilled in the art for implementation within the gist of the present technique. To be noted, in the drawings referred to in the description of the following embodiments, it is assumed that elements denoted by the same reference signs have substantially the same functions unless otherwise described.

### First Embodiment

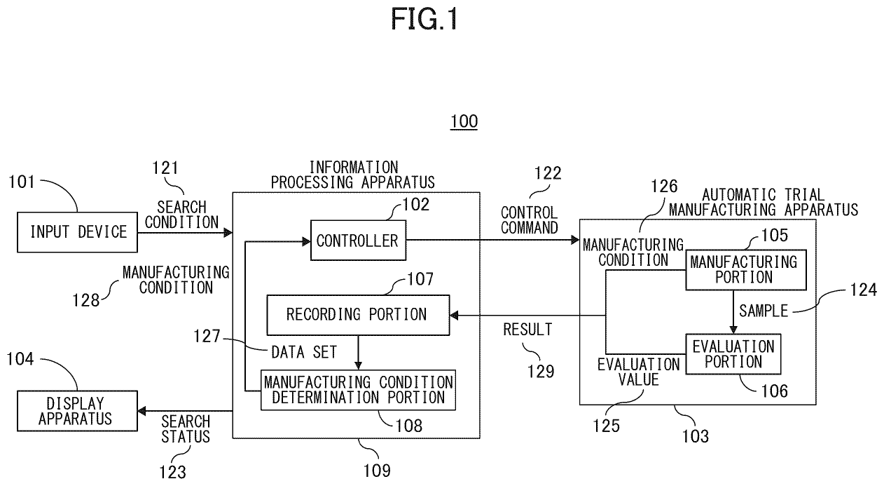

FIG. 1 is a block diagram of a manufacturing evaluation system 100 according to a first embodiment. The manufacturing evaluation system 100 is an example of a system. The manufacturing evaluation system 100 includes an information processing apparatus 109, an automatic trial manufacturing apparatus 103, an input device 101, and a display apparatus 104. The automatic trial manufacturing apparatus 103 is an example of a trial manufacturing apparatus.

In development of a material or the like, the manufacturing evaluation system 100 repetitively performs a search cycle in which the manufacturing evaluation system 100 automatically manufactures a sample 124 on the basis of a manufacturing condition 128, automatically evaluates the sample 124, and determines a next manufacturing condition 128 from a data set 127 including a manufacturing condition 126 and an evaluation value 125 serving as an evaluation result. The manufacturing evaluation system 100 executes the search cycle a plurality of times, and thus searches for the manufacturing condition 128 with which a desired sample 124 can be obtained. However, in the case of a conventional manufacturing evaluation system, there has been a case where the amount of improvement in the evaluation value of the sample per search cycle is small, where the evaluation value of the sample does not reach a value desired by a user, or where the efficiency of the search is low even in the case where the search cycle is repeated.

The manufacturing condition 128 (126) is a condition necessary for manufacturing the sample 124, and includes a raw material condition such as the kind, characteristics, and amount of the raw material, and a processing condition for stirring, heating, cooling, curing, and the like of the raw material. That is, the manufacturing condition 128 (126) can include information of a raw material used for manufacturing the sample 124, information of a mixing amount of the raw material used for manufacturing the sample 124, and a processing temperature (for example, curing temperature) in the manufacturing process of the sample 124. The manufacturing condition 128 (126) can include other conditions necessary for manufacturing the sample 124 if there is any. To be noted, the manufacturing condition 128 is a command value (target value) given to the automatic trial manufacturing apparatus 103. In addition, the manufacturing condition 126 is a measured value obtained from the automatic trial manufacturing apparatus 103.

The evaluation value 125 is a value indicating the performance related to the manufacturing condition 126, and can include, for example, a value evaluating a physical property of the sample 124, a resource required for manufacturing the sample 124, a cost required for manufacturing the sample 124, a time required for manufacturing the sample 124, and an environmental load required for manufacturing the sample 124. The physical property of the sample 124 is the performance of the manufactured sample 124, for example, an adhesive force, a fracture energy, an elastic modulus, a viscosity, an optical transmittance, or an electrical resistance, and these physical properties can be also included in the evaluation value 125. In addition, the obtained evaluation value 125 may be a value of one kind of evaluation, or may be values of a plurality of kinds of evaluation. As described above, an indicator other than those described above may be used for the evaluation value 125, and at least one of the indicators described above and other indicators may be used. Data in which these manufacturing conditions 126 and evaluation values 125 are associated with each other is accumulated in a data set 127, and the data set 127 is analyzed to determine the next manufacturing conditions 128. It is preferable that Bayesian optimization is used for determining the next manufacturing conditions 128, but a different optimization method such as the response surface method, regression analysis, or genetic algorithm may be used.

The automatic trial manufacturing apparatus 103 is a trial manufacturing apparatus that executes manufacture and evaluation of the sample in the plurality of search cycles, and includes a manufacturing portion 105 and an evaluation portion 106. The information processing apparatus 109 is an apparatus that receives input of a search condition 121, executes a determination process to determine the manufacturing condition 128, and causes the automatic trial manufacturing apparatus 103 to execute the manufacture and evaluation of the sample. The manufacturing portion 105 of the automatic trial manufacturing apparatus 103 executes a manufacturing process of manufacturing the sample 124 in accordance with a given manufacturing condition 128. The evaluation portion 106 of the automatic trial manufacturing apparatus 103 executes an evaluation process of evaluating the sample 124 manufactured by the manufacturing portion 105. The plurality of search cycles each include the determination process, the manufacturing process, and the evaluation process.

The information processing apparatus 109 includes one or more computers. A case where the information processing apparatus 109 includes one computer, that is, one processor will be described below as an example. The information processing apparatus 109 includes a central processing unit (CPU) serving as an example of the processor, a random access memory (RAM) that is a transitory storage device, a read-only memory (ROM) and a solid-state drive (SSD) that are non-transitory storage devices (recording media), and I/O that is an interface. The non-transitory storage device is an example of a computer-readable recording medium, and stores a program to cause the CPU to execute an information method including control processing for controlling each component of the apparatus, arithmetic processing, and the like.

To be noted, instead of the configuration described above, the information processing apparatus 109 including a processor may be constituted by, for example, a programmable logic device (PLD) such as a field programmable gate array (FPGA), an application specific integrated circuit (ASIC), a multi-purpose or dedicated computer incorporating a program, or a combination of all or some of these.

The information processing apparatus 109 has a function as a controller 102, a recording portion 107, and a manufacturing condition determination portion 108. The controller 102 generates a control command 122 on the basis of the manufacturing condition 128, and controls the automatic trial manufacturing apparatus 103 in accordance with the control command 122.

The manufacturing portion 105 of the automatic trial manufacturing apparatus 103 is an apparatus that manufactures the sample 124 on the basis of the manufacturing condition 128 corresponding to the control command 122. In the manufacture of the sample 124 processing such as weighing and dispensation of the raw material, and defoaming, heating and cooling, pressurization and de-pressurization, and curing of the material is performed. To be noted, the manufacture of the sample 124 is not limited to the processes described here, and manufacturing steps (manufacturing processes) required for the manufacture of the sample 124 can be included. Specifically, these manufacturing steps (manufacturing processes) are performed by using a robot or an automated machine.

The manufacturing portion 105 manufactures the sample 124 on the basis of the manufacturing condition 128 corresponding to the command, but it is possible that there is an error in the measured manufacturing condition 126 with respect to the manufacturing condition 128 of the command, depending on the control accuracy of the manufacturing portion 105. Therefore, the manufacturing portion 105 may output the measured manufacturing condition 126 to the information processing apparatus 109 as a result 129. To be noted, in the case where the difference between the manufacturing condition 126 and the manufacturing condition 128 is smaller than a predetermined value, the manufacturing condition 128 may be used as the result 129.

The evaluation portion 106 of the automatic trial manufacturing apparatus 103 is an apparatus that evaluates (measures) the sample 124. The evaluation portion 106 evaluates the sample 124, and outputs an evaluation value 125 that is an example of the evaluation result (measurement result). The evaluation value 125 is a value indicating the performance of the manufacturing condition 126, and can include, for example, a resource required for manufacturing the sample 124, a cost required for manufacturing the sample 124, a time required for manufacturing the sample 124, and an environmental load required for manufacturing the sample 124. In addition, the evaluation value 125 can include a value of a physical property of the sample 124, for example, an adhesive force, a fracture energy, an elastic modulus, a viscosity, an optical transmittance, or an electrical resistance. In addition, the evaluation value 125 may be a value obtained by converting an image such as a microscopic image into a numerical value as long as the evaluation value 125 serves as a goal of the development. As described above, an indicator other than those described above may be used for the evaluation value 125, and at least one of the indicators described above and other indicators may be used. The evaluation value 125 is output to the information processing apparatus 109 as the result 129.

To be noted, the evaluation value 125 is preferably a value indicating quantitative evaluation, but may be a value obtained by functional evaluation. In addition, pre-processing required for the evaluation may be included in the evaluation portion 106. The evaluation process is performed by, for example, using a robot or an automated machine.

The recording portion 107 obtains the result 129, and records the manufacturing condition 126 and the evaluation value 125 in the data set 127 in association with each other. To be noted, in the case where the difference between the manufacturing condition 126 and the manufacturing condition 128 is smaller than a predetermined value, the data set 127 may include the manufacturing condition 128 instead of the manufacturing condition 126. That is, the manufacturing condition included in the data set 127 includes a measured value obtained by the manufacturing process by the manufacturing portion 105, or a command value obtained by the determination process by the manufacturing condition determination portion 108. The data set 127 is stored in, for example, a storage device such as an SSD. To be noted, the recording portion 107 may be included in, for example, a server, and may be incorporated in a server on a cloud that performs processing remotely.

In the data set 127, not only a value of one search cycle but also the manufacturing conditions 126 (or 128) and the evaluation values 125 obtained in prior search cycles. In addition, in the case of the first search cycle where no data is accumulated, the data set 127 may use manufacturing conditions 126 (or 128) and evaluation values 125 obtained in a past search (development) different from the present series of search cycles as initial data. In this case, the initial data may be kept in the data set 127 when executing the second search cycle.

When operating the manufacturing condition determination portion 108, the operation needs to be defined, and a condition used for defining the operation will be referred to as a search condition 121. The search condition 121 includes a search setting related to the manufacturing condition 128 such as the amount of the raw material and the range for searching the processing condition, a search setting related to an allowable value of the evaluation value, and a search setting related to the overall operation such as a finishing condition of the search cycle and the search algorithm.

The search condition 121 is determined by a user as a temporal initial setting. Then, the information processing apparatus 109 repeatedly executes the search cycle, and the search condition 121 is changed appropriately during the execution of a plurality of search cycles.

The input device 101 is a device that the user operates to input the search condition 121 to the information processing apparatus 109. The input device 101 may include a keyboard and a mouse, but may be any device as long as input can be performed by the device. For example, the input device 101 may include a touch panel or a touch pad.

The manufacturing condition determination portion 108 executes a determination process of determining the manufacturing condition 128 by using the search condition 121 and the data set 127. The search algorithm used for determining the manufacturing condition 128 is preferably Bayesian optimization, but a different optimization method such as the response surface method, regression analysis, or genetic algorithm may be used. For example, the manufacturing condition determination portion 108 may be included in a server or the like, and may be included in a server on a cloud that performs processing remotely.

The display apparatus 104 displays an image of the search status 123 or the like output from the automatic trial manufacturing apparatus 103, and is specifically a display. The search status 123 includes a data analysis result based on the data set 127, such as an update status of the evaluation value 125.

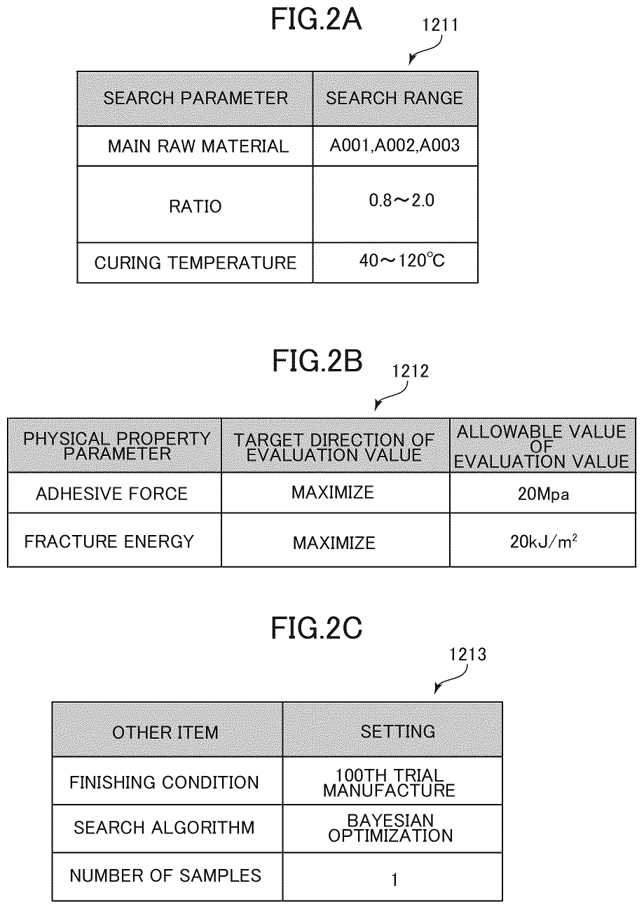

Specific description of the search condition 121 will be given. FIGS. 2A, 2B, and 2C are explanatory diagrams of part of the search condition 121 according to the first embodiment. The search condition 121 is not limited to those described below as long as the search condition 121 includes definition required for operating the automatic trial manufacturing apparatus 103. The search condition 121 includes a search setting 1211 related to the manufacturing condition 128, a search setting 1212 related to evaluation of the sample 124, and a search setting 1213 related to the overall operation. The search setting 1211 is an example of a first search setting, the search setting 1212 is an example of a second search setting, and the search setting 1213 is an example of a third search setting.

The search setting 1211 related to the manufacturing condition defines a search range corresponding to a search parameter or the like. That is, the search setting 1211 includes candidates for the next manufacturing condition 128.

The search parameter is a parameter (item) of the manufacturing condition to be searched for. Examples thereof include the main raw material used for manufacturing the sample 124, the mixing amount of the main raw material (for example, ratio of the main raw material), and the processing temperature (for example, the curing temperature). The ratio of the main raw material is, for example, the ratio of the amount of a curing agent to the amount of the main raw material.

The search range is a range (candidates for the manufacturing condition) in which the manufacturing condition corresponding to the search parameter can be changed. For example, in the case where a parameter that can be expressed by a numerical value such as the mixing amount (for example, the ratio) of the raw material or the processing temperature (for example, curing temperature) is set as the search parameter, one or more numerical values or a continuous numerical value range is set as the search range. In addition, not only the search range for each of a plurality of search parameters but also a search range for a combination of a plurality of search parameters may be set. For example, the search range may be a setting such as “the sum of the amount of the raw material A001 and the amount of the raw material A002 is 100”. In addition, the search range may be discrete values instead of a continuous value, and in the case of discrete values, the interval and number of division of the discrete values may be set in addition to the upper limit value and the lower limit value of the range. In addition, as the search range, information that is not expressed by numerical values, such as raw materials A001, A002, and A003 may be used. In this case, one of the raw materials A001, A002, and A003 is determined as the manufacturing condition 128.

As described above, a desired evaluation value is searched for by changing the manufacturing condition within the search range. To be noted, a manufacturing condition to be not changed is defined as a fixed value in the search setting 1211, and this fixed value is used as the manufacturing condition 128 for the sample 124.

The search setting 1212 related to the evaluation of the sample 124 defines an evaluation value parameter to be searched for, a target direction of the evaluation value, an allowable value of the evaluation value, and the like.

The evaluation value parameter defines a parameter (item) of the evaluation value desired for development of a material or the like, and one or more evaluation value parameters may be set. That is, it suffices as long as at least one evaluation value is set to be searched for. For example, the evaluation value parameter is a resource required for manufacturing the sample 124, a cost required for manufacturing the sample 124, a time required for manufacturing the sample 124, and an environmental load required for manufacturing the sample 124, and can also include a value of a physical property of the sample 124 such as an adhesive force, a fracture energy, an elastic modulus, a viscosity, an optical transmittance, or an electrical resistance.

The target direction of the evaluation value defines a direction in which the evaluation value is to be adjusted, such as a direction to increase (maximize) the evaluation value, a direction to decrease (minimize) the evaluation value, or a direction to make the evaluation value closer to a certain value.

In the case where there are a plurality of evaluation value parameters, that is, in the case where there are a plurality of kinds of evaluation values serving as targets, there is a case where evaluation values are in a trade-off relationship with each other, and a unique answer for the optimum manufacturing condition cannot be determined. To address this trade-off, an allowable value of each evaluation value is defined. The allowable value of the evaluation value is, for example, the lower limit value or the upper limit value of the allowable range. In the case where the allowable value of the evaluation value is the lower limit value of the allowable range of the evaluation value, an allowable value of the evaluation value is a value that is smaller than a target value but is acceptable. As a result of this, in the search cycle, a condition with which an evaluation value smaller than the allowable value is expected to be obtained is not determined as the next manufacturing condition, and trial manufacture of the sample 124 for which the evaluation value is smaller than the allowable value is not performed.

The search setting 1213 defines at least one of the finishing condition of the search cycle, the search algorithm, and the number of samples 124 to be formed in each search cycle. The finishing condition of the search cycle may be a condition that the search cycle is finished after the search cycle is repeated designated times, or that the search cycle is finished when the evaluation value 125 reaches a designated target value.

The search algorithm is an algorithm for determining the next manufacturing condition, and defines the optimization method and an internal algorithm used for the optimization method. Examples of the optimization method include Bayesian optimization, the response surface method, regression analysis, and genetic algorithm. In the case where Bayesian optimization is used as the optimization method, a kernel function, an acquisition function, an internal restriction, or the like is defined as the internal algorithm.

The number of samples to be manufactured in one cycle is the number of samples 124 to be manufactured in each search cycle. In some cases, the manufacture and evaluation of the sample 124 are more efficient when a plurality of samples are manufactured in one cycle than when one sample is manufactured in one cycle.

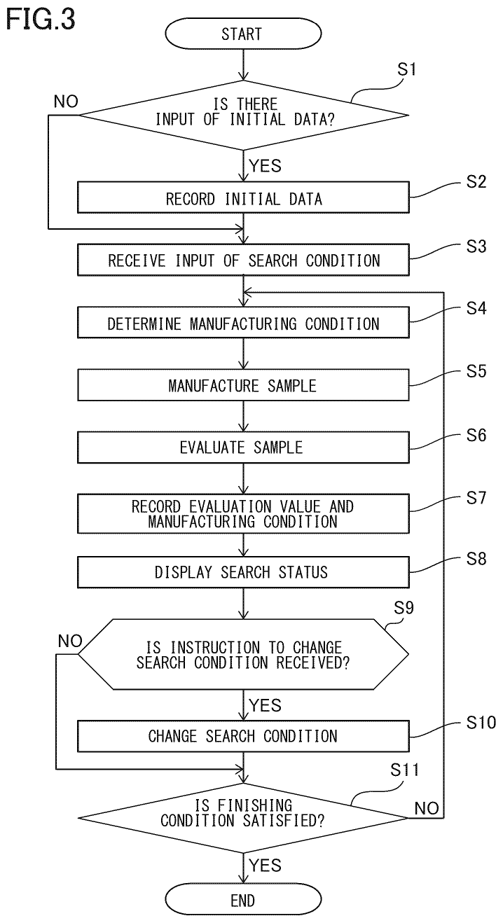

FIG. 3 is a flowchart of processing by the manufacturing evaluation system 100 according to the first embodiment. In step S1, the recording portion 107 determines whether or not input of initial data such as data that is obtained in past development and can be used for the development of this time is received.

In the case where the result of step S1 is YES, that is, in the case where input of the initial data is received, in step S2, the recording portion 107 records the initial data in the data set 127. In the case where the result of step S1 is NO, that is, in the case where input of the initial data is not received, the recording portion 107 leaves the data set 127 empty, and skips the processing of step S2.

Next, in step S3, the controller 102 receives input of the search condition 121. To be noted, the order of steps S1 and S2 and the step S3 may be switched.

A series of processing from step S4 to step S11 is a search cycle, and the manufacturing evaluation system 100 executes the search cycle a plurality of times.

In step S4, the manufacturing condition determination portion 108 determines the manufacturing condition 128 on the basis of the search condition 121 and the data set 127. The manufacturing condition 128 is a commanded value, that is, a target value.

Specifically, in step S4, the manufacturing condition determination portion 108 determines, in the next manufacturing condition 128, the kind of the main raw material, the mixing amount (for example, ratio) of the main raw material, the processing temperature (for example, curing temperature), and the like from candidates included in the search setting 1211. To be noted, as described above, the candidates can include information of a plurality of kinds of raw materials, information of a range of the mixing amount of the raw materials, and information of the processing temperature. At this time, the manufacturing condition determination portion 108 determines the manufacturing condition 128 on the basis of the search algorithm to optimize the evaluation value 125.

To be noted, in the case where the data set 127 includes no data, the manufacturing condition determination portion 108 may randomly determine the manufacturing condition 128, may determine the manufacturing condition 128 on the basis of an orthogonal array of design of experiments, or may receive designation of the manufacturing condition 128 from the user.

Next, in step S5, the controller 102 generates the control command 122 on the basis of the search condition 121 and the manufacturing condition 128, and outputs the control command 122 to the automatic trial manufacturing apparatus 103. The manufacturing portion 105 of the automatic trial manufacturing apparatus 103 having obtained the control command 122 manufactures the sample 124 in accordance with the control command 122. That is, the manufacturing portion 105 executes a manufacturing process of manufacturing the sample 124 in accordance with the manufacturing condition 128. At this time, the manufacturing portion 105 outputs a manufacturing condition 126 obtained by actual measurement.

Next, in step S6, the evaluation portion 106 executes an evaluation process of evaluating the sample 124 manufactured by the manufacturing 105. At this time, the evaluation portion 106 outputs the evaluation value 125 serving as an evaluation result.

Next, in step S7, the recording portion 107 records the result (data) 129 including the evaluation value 125 and the manufacturing condition 126 in the data set 127. Next, in step S8, the controller 102 displays an image corresponding to the search status 123 on the display apparatus 104. To be noted, the order of the processing of step S7 and the processing of step S8 may be switched.

Incidentally, in the initial stage of the search cycle, the user does not necessarily know an appropriate search condition 121. As the search cycle progresses, sometimes the user comes to know an appropriate search condition 121 through the search status 123. For example, in some cases, the user determines that the search condition 121 needs to be changed when looking at an image corresponding to the search status 123. In the present embodiment, the controller 102 takes a state in which change of the search condition 121 by the user can be received during execution of the plurality of search cycles. That is, the user inputs the changed search condition 121 to the information processing apparatus 109 at an arbitrary timing in steps S4 to S8 by using the input device 101.

The search status 123 of the present embodiment is a data analysis result obtained by using the data set 127, and is, for example, at least one of a transition history of the evaluation value 125, an estimation accuracy of a model, a relationship between the manufacturing condition 126 and the evaluation value 125, and the distribution of the evaluation value 125.

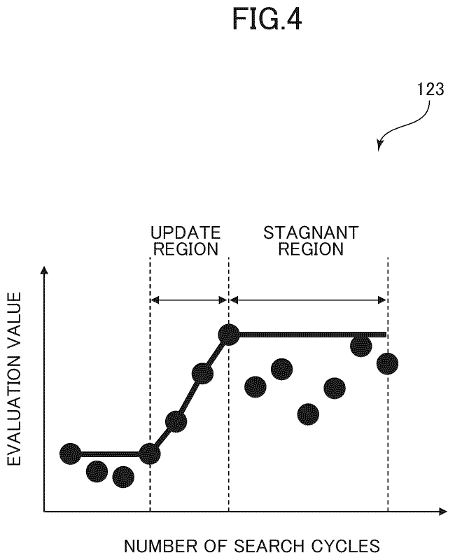

FIG. 4 is an explanatory diagram of an example of the search status 123 according to the first embodiment. The search status 123 of FIG. 4 indicates the transition history of the evaluation value 125. The controller 102 displays an image illustrated in FIG. 4 indicating the transition history of the evaluation value 125 on the display apparatus 104. In the image displayed on the display apparatus 104, the evaluation value 125 is plotted with respect to the number of search cycles. The plotted dots represent evaluation values 125 obtained by evaluation in respective search cycles.

The solid line in FIG. 4 indicates the best evaluation value 125 obtained thus far in each executed search cycle. As a result of this, the user can grasp an update region and a stagnant region of the evaluation value 125.

In the case where the stagnant region continues, there is a possibility that at least one of the search algorithm, the search parameter, the search range, and the allowable value of the evaluation value 125 is not appropriate in the search condition 121. The user can expect improvement (update) of the evaluation value 125 by changing at least one of the search algorithm, the search parameter, the search range, and the allowable value of the evaluation value 125 in the search condition.

In addition, similarly, in the case where the stagnant region continues, the user can also immediately finish the search by changing the finishing condition of the search cycle in the search condition 121 to the current search cycle number. As a result of this, the user can immediately transition to examination of a different matter.

In the case where there are a plurality of kinds of evaluation values, the controller 102 may generate the graph illustrated in FIG. 4 individually for each of the plurality of kinds of evaluation values, and present the graphs to the user. In addition, whether a plurality of kinds of physical properties are good or bad may be summarized in one indicator such as a hypervolume, and the indicator may be presented to the user.

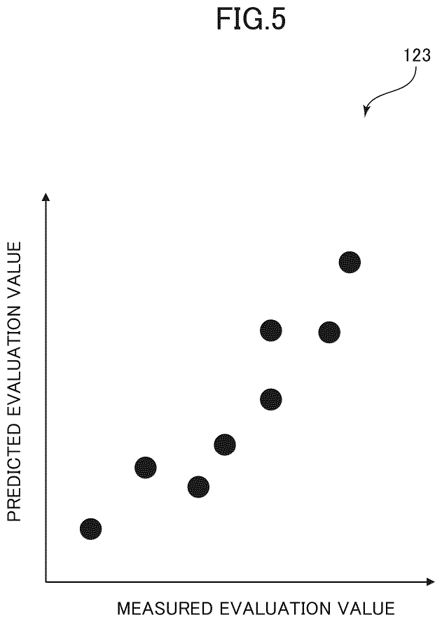

FIG. 5 is an explanatory diagram of an example of a search status 123 according to the first embodiment. The search status 123 of FIG. 5 indicates the estimation accuracy of a model. The controller 102 displays the image illustrated in FIG. 5 indicating the estimation accuracy of the model on the display apparatus 104. In the image displayed on the display apparatus 104, estimated values of the evaluation values are plotted as dots with respect to the measured values of the evaluation values.

The measured value of the evaluation value 125 is a value included in the data set 127. When determining the next manufacturing condition 128, the manufacturing condition determination portion 108 generates a model for estimating the evaluation value 125 from the past manufacturing condition 126 by using the data set 127.

Next, the manufacturing condition determination portion 108 obtains, on the basis of this model, the manufacturing condition 128 with which a good evaluation value can be obtained, and outputs the next manufacturing condition 128. Therefore, if the accuracy of the model is low, the accuracy of the next manufacturing condition 128 is also low, and a good evaluation value 125 cannot be obtained. In the case where the finishing condition is a condition that the evaluation value is equal to or larger than a threshold value, the number of search cycles increases.

In the case where the accuracy of the model is low, there is a possibility that at least the search parameter is not appropriate among the search parameter and the search range. The user can change at least the search parameter among the search parameter and the search range in the search condition 121, and thus improvement in the accuracy of the model, reduction of the difference between the predicted value and the measured value of the evaluation value, and improvement (update) of the evaluation value in later search cycles can be expected.

In the case where there are a plurality of kinds of evaluation values, the controller 102 may generate the graph of FIG. 5 individually for each of the plurality of kinds of evaluation values and present the graphs to the user. In addition, transition of the estimation accuracy with respect to the search cycle number may be displayed. At this time, the estimation accuracy with respect to an arbitrary search cycle number may be displayed, the estimation accuracy for a different search cycle number may be displayed for each time, or estimation accuracies for different search cycle numbers may be displayed side by side.

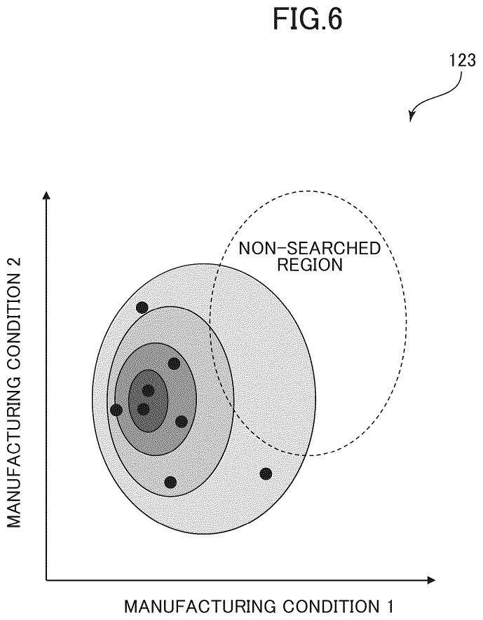

FIG. 6 is an explanatory diagram of an example of the search status 123 according to the first embodiment. The search status 123 of FIG. 6 illustrates a relationship between two manufacturing conditions and evaluation values. The controller 102 displays an image indicating a relationship illustrated in FIG. 6 on the display apparatus 104. In the image displayed on the display apparatus 104, evaluation values 125 are expressed by contours with respect to the two manufacturing conditions. Each dot represents data included in the data set 127. The manufacturing condition determination portion 108 estimates the evaluation value from various manufacturing conditions by using a model, and the controller 102 displays the result thereof on the display apparatus 104 as a contour drawing.

In the case where the transition of the evaluation value 125 is stagnant and the non-searched region illustrated in FIG. 6 is large, the user can change the search algorithm of the search condition 121 to a search algorithm prioritizing the non-searched region. In addition, in the case where the user comes to know a promising region where the evaluation value is good in FIG. 6, the user can change the search algorithm of the search condition 121 to a search algorithm prioritizing a promising region. As a result of this, improvement (update) of the evaluation value can be expected.

To be noted, in the case where the user changes the search range, the search range may be changed to a range circled by using the input device 101 such as a mouse on the displayed image illustrated in FIG. 6. In addition, in the case where there are three or more manufacturing conditions, the recording portion 107 may display an image of a graph illustrated in FIG. 6 for two manufacturing conditions selected by the user on the display apparatus 104, or an image of a multi-dimensional graph such as a parallel coordinate plot may be displayed on the display apparatus 104. In the case where there are a plurality of kinds of evaluation values, the controller 102 may generate the graph of FIG. 6 individually for each of the plurality of kinds of evaluation values and present the graph to the user.

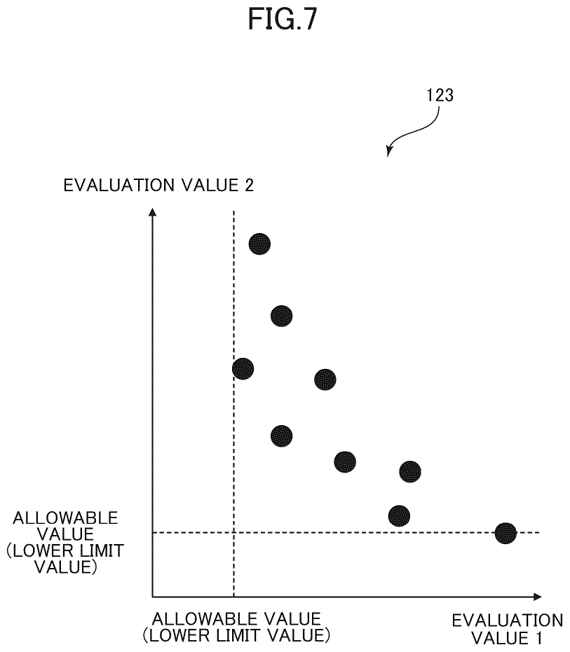

FIG. 7 is an explanatory diagram of an example of the search status 123 according to the first embodiment. The search status 123 of FIG. 7 illustrates a distribution of two kinds of evaluation values 125. The controller 102 displays an image indicating a scatter plot of the two kinds of evaluation values included in the data set 127 illustrated in FIG. 7 on the display apparatus 104.

In the case where there are two kinds of evaluation values, the user can grasp the relationship between the two kinds of evaluation values by looking at the scatter plot. In the case where the user comes to know that there is a proportional relationship between the two kinds of evaluation values by looking at the image illustrated in FIG. 7, the user can delete an evaluation value parameter of a lower priority among the evaluation value parameters of the search condition 121. As a result of this, improvement (update) of the evaluation value can be expected in later search cycles.

In addition, in the case where the transition of the evaluation value is stagnant and the evaluation value is sufficiently close to the target value, the user preferably changes the allowable value of the evaluation value to be closer to the target value. As a result of this, improvement (update) of the evaluation value can be expected.

To be noted, in the case where the user changes the allowable value of the evaluation value, the allowable value of the evaluation value may be changed to value of a position input by using the input device 101 such as a mouse on the displayed image illustrated in FIG. 7. In addition, in the case where there are three or more kinds of evaluation values, the controller 102 may display an image of a graph illustrated in FIG. 7 for two kinds of evaluation values selected by the user on the display apparatus 104. In addition, an image of a multi-dimensional graph such as a three-dimensional scatter plot or a parallel coordinates plot may be displayed on the display apparatus 104.

To be noted, the image corresponding to the search status 123 based on the data set 127 is not limited to these as long as the user can understand the search status 123.

In addition, the controller 102 preferably displays an image indicating the search status 121 on the display apparatus 104. As a result of this, the user can grasp the search condition 121 that has been already input, and can check which item of the search condition 121 should be changed.

In addition, the controller 102 may display an image corresponding to an image indicating a change candidate of the search condition 121 on the display apparatus 104 when displaying the image corresponding to the search status 123 on the display apparatus 104. Then, the controller 102 may change the search condition 121 to a change candidate selected by the user.

In step S9, the controller 102 determines whether or not change in the search condition 121 is received. In the case where the result of step S9 is YES, that is, in the case where change in the search condition 121 is received, the controller 102 overwrites the set search condition 121 and thus changes the search condition 121 in step S10. In the case where the result of step S9 is NO, that is, in the case where the change in the search condition 121 is not received, the controller 102 skips the processing of step S10.

Next, in step S11, the controller 102 determines whether or not the finishing condition is satisfied. In the case where the result of step S11 is NO, that is, in the case where the finishing condition is not satisfied, the controller 102 returns to the processing of step S4, and executes the next search cycle. In the case where the result of step S11 is YES, that is, in the case where the finishing condition is satisfied, the controller 102 finishes the processing.

As described above, the manufacturing evaluation system 100 executes a plurality of search cycles. Here, while the plurality of search cycles are executed, a search cycle that is currently executed will be referred to as a first search cycle, a search cycle executed prior to (in the present embodiment, immediately before) the first search cycle will be referred to as a second search cycle, and a search cycle that is to be executed next to the first search cycle will be referred to as a third search cycle.

In step S7 of the second search cycle, the recording portion 107 records data (result 129) including the evaluation value 125 obtained in the second search cycle and the manufacturing condition 126 obtained in the second search cycle in the data set 127. As a result of this, the data set 127 includes data (result 129) obtained from the automatic trial manufacturing apparatus 103 in the second search cycle and search cycles before the second search cycle. To be noted, in the data recorded in the data set 127, in the case where the manufacturing condition 128 is used instead of the manufacturing condition 126, data obtained from the automatic trial manufacturing apparatus 103 is only the evaluation value 125.

In the first embodiment, in step S4 of the first search cycle next to the second search cycle, the manufacturing condition determination portion 108 of the information processing apparatus 109 determines the manufacturing condition 128 for the manufacturing process in the first search cycle by using the search condition 121 and the data set 127 including data (result 129) of the second search cycle and cycles before the second search cycle. The data set 127 includes the manufacturing condition 126 (or 128) of the manufacturing process and the evaluation value 125 that is an evaluation result of the evaluation process of the second search cycle and search cycles before the second search cycle.

Next, in step S5 of the first search cycle, the controller 102 generates a control command 122 on the basis of the search condition 121 and the manufacturing condition 128 and outputs the control command 122 to the automatic trial manufacturing apparatus 103, and thus the manufacturing portion 105 of the automatic trial manufacturing apparatus 103 executes the manufacturing process of manufacturing the sample 124.

Next, in step S6 of the first search cycle, the evaluation portion 106 executes the evaluation process of evaluating the sample 124 manufactured by the manufacturing portion 105, and outputs the evaluation value 125 serving as an evaluation result.

Then, in the case where the result of step S9 of the first search cycle is YES, in step S10, the controller 102 changes the search condition 121 that is to be used for the third search cycle and search cycles thereafter.

As described above, the controller 102 of the information processing apparatus 109 is configured to be capable of changing the search condition 121 during execution of the plurality of search cycles. In the first embodiment, the controller 102 of the information processing apparatus 109 is configured to be capable of receiving an instruction to change the search condition 121. Further, in the case of receiving the instruction, the controller 102 of the information processing apparatus 109 changes the search condition 121 in accordance with the instruction.

As described above, the setting of the search condition 121 is changed by the user during execution of the plurality of search cycles, and thus a manufacturing condition close to an evaluation value desired by the user can be obtained in a small number of search cycles.

In addition, even if appropriate setting of the search condition 121 is not performed at first, since the search condition 121 is changed by the user in accordance with the search status 123, a better manufacturing condition can be found in a smaller number of search cycles, and the search (development) can be performed more efficiently.

### Second Embodiment

A second embodiment will be described. In the description below, it is assumed that elements denoted by the same reference signs as in the first embodiment have substantially the same configurations and functions as those described in the first embodiment unless described otherwise, and part different from the first embodiment will be mainly described. The configuration of the manufacturing evaluation system of the second embodiment is similar to the configuration of the manufacturing evaluation system 100 of the first embodiment, and therefore the description thereof will be omitted.

Although the search condition 121 is changed by the user in the first embodiment described above, the information processing apparatus 109 automatically changes the search condition 121 in the second embodiment.

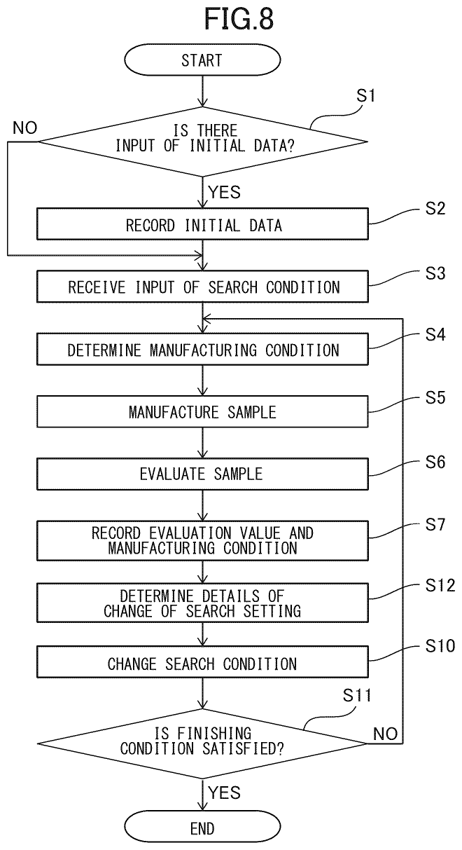

FIG. 8 is a flowchart of the processing of the manufacturing evaluation system according to the second embodiment. The flowchart illustrated in FIG. 8 is different from the flowchart of the first embodiment illustrated in FIG. 3 in that steps S8 and S9 are omitted and step S12 is added between steps S7 and S10. To be noted, the processing of displaying an image of the search status 123 on the display apparatus 104 in step S8 may or may not be omitted.

In step S12, the controller 102 automatically determines the details of the change of the search condition 121 on the basis of the search status 123 based on the data set 127. To be noted, the details of the change of the search condition 121 also include a case where there is no change. Then, in step S10, the controller 102 overwrites the set search condition 121 and thus changes the search condition 121. As described above, the controller 102 automatically changes the search condition 121 on the basis of the search status 123. For example, the controller 102 may change the search condition 121 to a predetermined condition in the case where a value based on the search status 123 exceeds a threshold value that is provided in advance.

For example, specifically, in the case where the transition of the evaluation value is such that the evaluation value does not change in a predetermined number of search cycles and the estimation accuracy expressed by a coefficient of determination is lower than a predetermined value, the controller 102 may calculate the importance of the search parameter for the evaluation value by, for example, permutation importance in which the importance of a search parameter is obtained by analyzing a model, and may delete a search parameter of a low importance from the search condition 121. As a result of this, the estimation accuracy is improved, and improvement (update) of the evaluation value can be expected.

In addition, in the case where the transition of the evaluation value is such that the evaluation value does not change in a predetermined number of search cycles and there is data between the allowable value and the target value of the evaluation value, the controller 102 may change the allowable value of the evaluation value to a value equal to that data. In the case where there are a plurality of pieces of data therebetween, the allowable value of the evaluation value may be changed to a value equal to any of the pieces of data, but it is preferable that the allowable value is changed to a value equal to the data of the median. As a result of this, a manufacturing condition from which a value close to the target value is expected is proposed, and thus the improvement (update) of the evaluation value can be expected. To be noted, the method to change the search condition 121 is not limited to what has been described above as long as the search setting can be automatically changed in accordance with the search status.

### Example 1

The manufacturing condition of the sample 124 that simultaneously achieved a good adhesive force and a good fracture energy as an adhesive was searched for by using the manufacturing evaluation system 100 of the first embodiment.

The sample 124 was a cured product of an adhesive obtained by heating and thus curing an adhesive obtained by mixing a main raw material and a curing material. The manufacturing portion 105 was a combination of a robot hand and a planetary centrifugal mixer. In the manufacturing process, the manufacturing portion 105 weighed the main raw material and the curing material by using the robot hand, and stirred the mixture by using the planetary centrifugal mixer.

To manufacture a sample for measurement of the adhesive force, the manufacturing portion 105 also used the robot hand to operate a syringe to drop a solution of the stirred adhesive onto an aluminum plate, and the adhesive was sandwiched by the aluminum plate and a stainless steel plate with a shim to achieve a certain thickness.

To manufacture a sample for measurement of the fracture energy, the manufacturing portion 105 dropped a solution of the stirred adhesive onto a glass plate coated with a releasing film, and the adhesive was sandwiched by the glass plate and another glass plate with a shim to achieve a certain thickness. The manufacturing portion 105 put this joined article in an oven by using the robot hand, and heated the article for 30 minutes. The manufacturing portion 105 peeled off the sample for fracture energy measurement from the glass plates by using the robot hand, and cut the peeled sample into a dumbbell shape.

The evaluation portion 106 was a combination of a robot hand and a tensile/indentation tester. The evaluation portion 106 set the sample manufactured by the manufacturing portion 105 to the tensile/indentation tester by using the robot hand. The adhesive force was measured by an indentation test, and the fracture energy was measured by a tensile test. The measurement values were obtained by the tensile/indentation tester.

In Example 1, since there was no past examination, the initial data set 127 was set to be empty. In addition, the initial search condition 121 was set as follows. That is, the 100th search cycle being executed was set as the finishing condition of the search cycle. In addition, the search algorithm was multi-purpose Bayesian optimization using expected hypervolume improvement. The number of samples to be manufactured in one cycle was set to 1 for each of the sample for measurement of the adhesive force and the sample for measurement of the fracture energy.

To be noted, in the case where the data set 127 was empty, the manufacturing condition 128 was configured to be proposed randomly within the search range.

The search setting 1211 related to the manufacturing condition was as illustrated in the example of FIG. 2A. As the search parameters, the main raw material, the ratio of the amount of the curing agent to the amount of the main raw material, and the curing temperature were set as the search parameters.

Three kinds of material candidates (A001, A002, and A003) were set as the search range for the main raw material. A numerical range of 0.8 to 2.0 was set as the search range for the ratio of the amount of the curing agent to the amount of the main raw material. A numerical range of 40° C. to 120° C. was set as the search range for the curing temperature.

The search setting 1212 related to the evaluation value was as illustrated in the example of FIG. 2B. The adhesive force and the fracture energy were set as the evaluation value parameters. A direction to maximize the evaluation value was set as the target direction for both the adhesive force and the fracture energy.

The allowable value (lower limit) of the evaluation value for the adhesive force was set to 20 MPa, and the allowable value (lower limit) of the evaluation value for the fracture energy was set to 20 kJ/m². The target value of the adhesive force was set to 30 MPa or more, and the target value of the fracture energy was set to 120 kJ/m² or more.

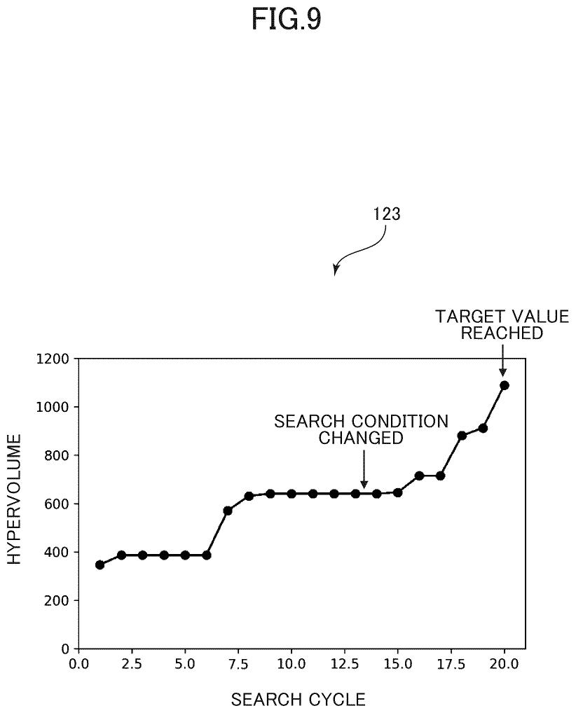

The search cycle was repeated a plurality of times by using the manufacturing evaluation system 100. As the search status 123, an image illustrated in FIG. 9 was displayed on the display apparatus 104. FIG. 9 is an explanatory diagram of the search status 123 according to Example 1. The search status 123 of FIG. 9 indicates the hypervolume of the evaluation values of two physical properties (adhesive force and fracture energy) with respect to the search cycle.

In the search status 123 illustrated in FIG. 9, the update of the hypervolume was stagnant. Therefore, the search condition 121 was changed at the 13th search cycle. In the change, the raw material A002 that was deemed not promising in the search cycles thus far was removed from the search ranged. The 14th search cycle and the search cycles after that were performed in this state, and the hypervolume was updated in the 16th search cycle. The update of the hypervolume continued, and the target values were reached at the 20th search cycle. Therefore, the finishing condition in the search condition 121 was changed to the trial manufacture number (search cycles) of 20 to finish the search cycle.

As described above, as illustrated in FIG. 2C, the trial manufacture number (search cycle) was initially set to 100, but since the search condition 121 was changed in accordance with the search status 123 during execution of the search cycles, the evaluation values for both of the adhesive force and the fracture energy reached the target values at the 20th search cycle. From this, it was found that efficient development was successfully performed.

### Example 2

Material development was described in Example 1, but Example 2 is also effective in various designing and development other than material development. In Example 2, an example in which a dicing processing method of glass was developed by using the manufacturing evaluation system 100 of the first embodiment will be described. Although it is preferable that the processing is performed in a short time in the dicing process of glass, if dicing is performed quickly, there is a risk that chipping, which is a defect, increases, and the yield decreases. In Example 2, a processing condition with which the processing time is short and the chipping does not occur much was searched for.

In the manufacturing portion 105, the sample 124 was manufactured as follows. A flat glass plate that was yet to be processed was moved to a dicing position by using the robot hand, then the dicing blade was brought into contact with the flat glass plate while the dicing blade was rotating, and the flat glass plate was moved and thus cut. At this time, the dicing was performed by using a cutting fluid. Then, the glass was moved to a high-pressure cleaning machine by using the robot hand, and cleaning and drying were performed. The sample 124 that was a cut glass obtained in this manner was conveyed to the evaluation portion 106 by using the robot hand.

The evaluation portion 106 was a device that automatically counted chipping. The evaluation portion 106 obtained an image of a cut surface by using a microscope, and chipping was counted. This process was performed in a scanning manner, and thus chipping in all the cut surfaces was counted. At this time, in the determination of chipping, image processing was performed, and a defect of a certain size or more was determined as chipping.

In Example 2, the number of chipping and the processing time taken for cutting were used as the evaluation value 125.

In Example 2, since there was no past examination, the initial data set 127 was set to be empty. In addition, the initial search condition 121 was set as follows. That is, the 50th search cycle being executed was set as the finishing condition of the search cycle. In addition, the search algorithm was multi-purpose Bayesian optimization using expected hypervolume improvement. The number of samples to be manufactured in one cycle was set to 1.

To be noted, in the case where the data set 127 was empty, the manufacturing condition 128 was configured to be proposed randomly within the search range.

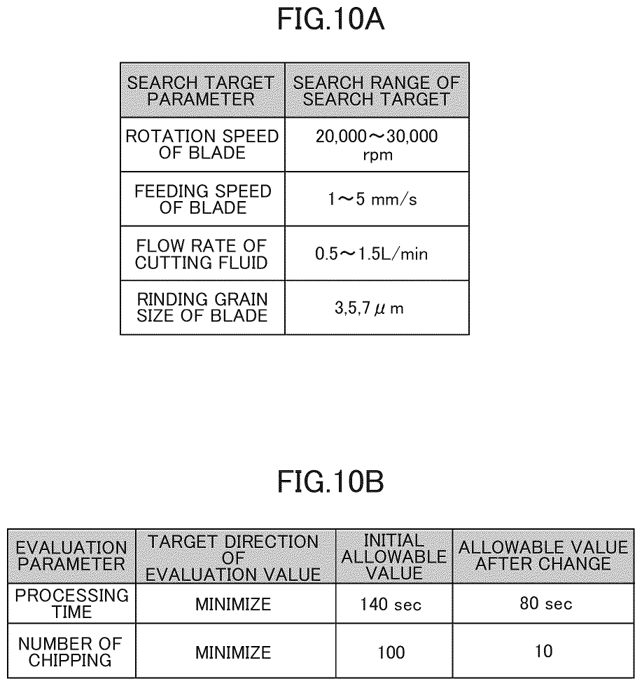

The search setting 1211 related to the manufacturing condition was as illustrated in the example of FIG. 10A. As the search parameters, the rotation speed of the blade, the feeding speed of the blade, the flow rate of the cutting fluid, and the grinding grain diameter of the blade were set.

A numerical range of 20000 rpm to 30000 rpm was set as the search range for the rotation speed of the blade. A numerical range of 1 mm/s to 5 mm/s was set as the search range for the feeding speed of the blade. A numerical range of 0.5 L/min to 1.5 L/min was set as the search range for the flow rate of the cutting fluid. Candidates of three kinds of sizes (3 μm, 5 μm, and 7 μm) were set as the search range for the grinding grain diameter of the blade.

The search setting 1212 related to the evaluation value was as illustrated in the example of FIG. 10B. The processing time and the number of chipping were set as the evaluation value parameters. A direction to minimize the evaluation value was set as the target direction for both of the processing time and the number of chipping.

The target values in Example 2 were set to three or less chippings and a processing time of 80 seconds or less.

In Example 2, the allowable values of the evaluation values were changed during execution of the cycles. In the initial stage (1 st to 20th search cycles), loose allowable values were set to grasp the relationship between the manufacturing condition and the evaluation values in a wide range. Specifically, the allowable value (upper limit) of the evaluation value for the processing time was set to 140 seconds, and the allowable value (upper limit) of the evaluation value for the number of chipping was set to 100. After the change (in the 21st to 30th search cycles), stricter allowable values were set to approach the desired target values. Specifically, the allowable value (upper limit) of the evaluation value for the processing time was set to 80 seconds, and the allowable value (upper limit) of the evaluation value for the number of chipping was set to 10.

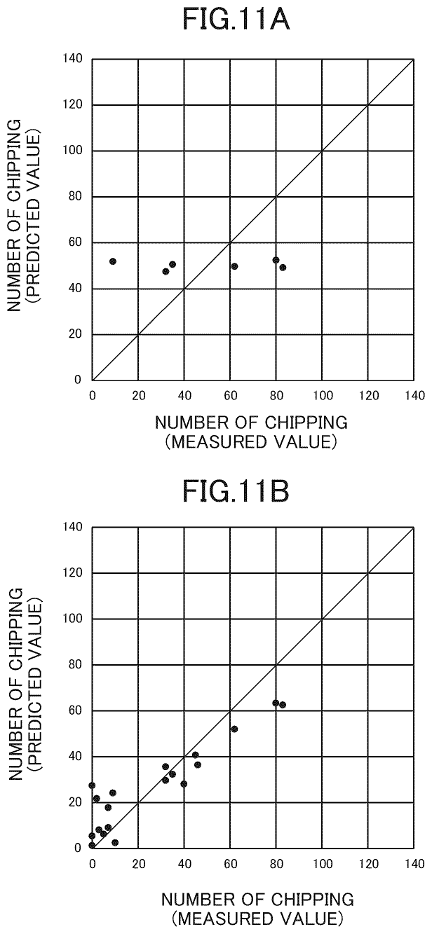

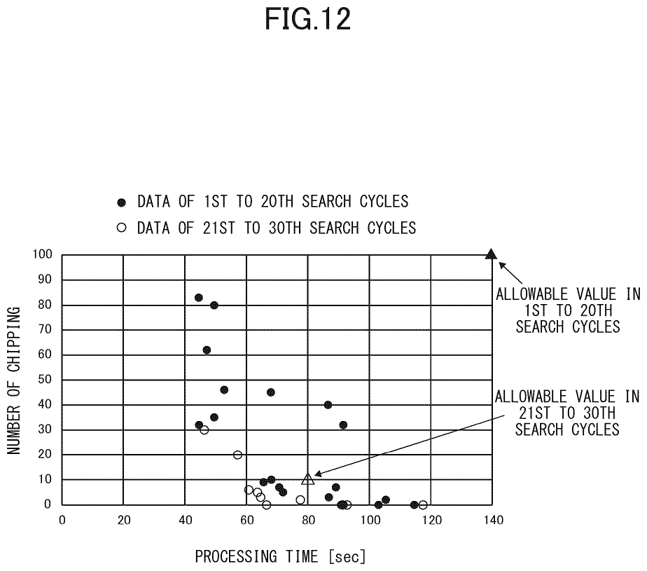

The search cycle was repeated a plurality of times by using the manufacturing evaluation system 100. As the search status 123, images illustrated in FIGS. 11A, 11B, and 12 were displayed on the display apparatus 104. FIGS. 11A, 11B, and 12 were explanatory diagrams of the search status 123 according to Example 2. FIGS. 11A and 11B illustrate the estimation accuracy of a model. The search status 123 of FIG. 11A indicates the estimation accuracy of a model obtained from data at the time when the 6th search cycle was finished, and the search status 123 of FIG. 11B indicates the estimation accuracy of a model obtained from data at the time when the 20th search cycle was finished. The search status 123 of FIG. 12 indicates the processing time and the number of chipping obtained thus far.

When not many search cycles have been performed, the amount of data is small and thus the accuracy of the model is low. FIG. 11A illustrates the estimation accuracy of a model obtained from data at the time when the 6th search cycle was finished as an example. As illustrated in FIG. 11A, the accuracy of the model was low, and therefore the search cycle was continued without changing the search condition 121. FIG. 11B illustrates the estimation accuracy of a model obtained from data at the time when the 20th search cycle was finished. As illustrated in FIG. 11B, since the amount of data increased, the accuracy of the model was improved, and it was possible to grasp the relationship between the manufacturing condition and the evaluation value with a higher accuracy. However, looking at FIG. 12 illustrating the processing time and the number of chipping at the time when the 20th search cycle was finished, the obtained values were better than the allowable values but did not reach the target values.

In the case where the allowable values are far from the Pareto front of the solutions, the entirety of the wide Pareto front is subjected to the search, which leads to low efficiency. Since a certain degree of accuracy was obtained form the model, setting to make the allowable values closer to the region of the target values was performed to improve the efficiency, and the search cycle was further continued. In the 21 st cycle and the search cycles thereafter, values better than the allowable values after the change were obtained at a high percentage as illustrated in FIG. 12, and the target values were reached at the 30th search cycle. To be noted, in the multi-purpose Bayesian optimization using expected hypervolume improvement used as the search algorithm, the manufacturing condition is determined while expecting the values to be better than the allowable values. However, since the evaluation value is sometimes low when manufacture and evaluation are actually performed, the obtained data is not necessarily better than the allowable value. Since the target values were reached, the finishing condition in the search condition 121 was changed to the trial manufacture number (search cycles) of 30 to finish the search cycle.

As described above, although the trial manufacture number (search cycle) was initially set to 50, the search condition 121 was changed in accordance with the search status 123 during execution of the search cycles. As a result of this, the evaluation values for both of the processing time and the number of chippings reached the target values at the 30th search cycle. From this, it was found that efficient development was successfully performed.

### OTHER EXAMPLES

The present disclosure is effective for other cases where design by simulation is difficult, in addition to the design and development described in Examples 1 and 2. For example, the present disclosure is also effective for design of shapes, layouts, and electronic circuits for improvement in terms of durability and manufacture variations.

In the design of shapes or layouts, numerical parameters such as dimensions are adjusted as the manufacturing condition 126. In the manufacturing portion 105, a sample is automatically manufactured by, for example, a computer numerical control (CNC) machine or a 3D printer. The evaluation portion 106 includes a device that automatically obtains an evaluation value matching the needs of development.

In the design of an electronic circuit, numerical parameters such as constants of circuit elements and dimensions of the wiring are adjusted as the manufacturing condition 126. In the manufacturing portion 105, a sample is automatically manufactured by arranging and soldering the circuit elements by using a robot hand. The evaluation portion 106 includes a device that automatically obtains an evaluation value matching the needs of development.

As described above, according to the present disclosure, a technique advantageous for performing the search more efficiently is provided.

### OTHER MODIFICATION EXAMPLES

The present disclosure is not limited to the embodiments described above, and the embodiments can be modified in many ways within the technical concept of the present disclosure. For example, at least two of the plurality of embodiment and the plurality of examples may be combined. In addition, the effects described in the embodiments are merely enumeration of the most preferable effects that can be obtained from the embodiments of the present disclosure, and the effects of the embodiments of the present disclosure are not limited to those described in the embodiments.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-153985, filed Sep. 6, 2024, and Japanese Patent Application No. 2025-125206, filed Jul. 25, 2025, which are hereby incorporated by reference herein in their entirety.

What is claimed is:

1. A system comprising a trial manufacturing apparatus and an information processing apparatus and configured to execute a plurality of search cycles,
wherein the information processing apparatus is configured to receive input of a search condition and execute a determination process of determining a manufacturing condition for a sample in each of the plurality of search cycles,
wherein the trial manufacturing apparatus is configured to, in each of the plurality of search cycles, execute a manufacturing process of manufacturing the sample in accordance with the manufacturing condition determined in the determination process, and execute an evaluation process of evaluating the sample manufactured in the manufacturing process and outputting an evaluation result,
wherein the information processing apparatus is configured to, in the determination process in a first search cycle among the plurality of search cycles, determine the manufacturing condition for the manufacturing process in the first search cycle by using the search condition and a data set including data obtained in a second search cycle and a search cycle executed before the second search cycle among the plurality of search cycles, the second search cycle being earlier than the first search cycle in an execution order, and
wherein the information processing apparatus is configured to change the search condition for a third search cycle and a search cycle after the third search cycle among the plurality of search cycles, the third search cycle being next to the first search cycle in the execution order.

2. The system according to claim 1, wherein in a case where an instruction to change the search condition is received, the information processing apparatus is configured to change the search condition in accordance with the instruction.

3. The system according to claim 1, wherein the information processing apparatus is configured to automatically change the search condition in accordance with a search status based on the data set.

4. The system according to claim 1, wherein the data set includes a measured manufacturing condition obtained in the manufacturing process, or the manufacturing condition obtained in the determination process.

5. The system according to claim 1,
wherein the search condition includes a first search setting including manufacturing condition candidates, and
wherein the information processing apparatus is configured to determine the manufacturing condition for the manufacturing process from the manufacturing condition candidates included in the first search setting.

6. The system according to claim 5,
wherein the manufacturing condition includes information of a raw material used for manufacturing the sample, and
wherein the first search setting includes information of a plurality of kinds of raw materials as the manufacturing condition candidates.

7. The system according to claim 5,
wherein the manufacturing condition includes information of a mixing amount of a raw material used for manufacturing the sample, and
wherein the first search setting includes information of a range of the mixing amount as the manufacturing condition candidates.

8. The system according to claim 5,
wherein the manufacturing condition includes information of a processing temperature in the manufacturing process, and
wherein the first search setting includes information of a range of the processing temperature as the manufacturing condition candidates.

9. The system according to claim 1,
wherein the search condition includes a second search setting related to at least one physical property of the sample, and
wherein the information processing apparatus is configured to determine the manufacturing condition on a basis of a search algorithm to optimize the physical property in the determination process.

10. The system according to claim 1, wherein the search condition includes a third search setting including at least one of a finishing condition of the search cycle, a search algorithm used in the determination process, and a number of the samples manufactured in the manufacturing process of each search cycle of the trial manufacturing apparatus.

11. The system according to claim 1, wherein the sample is a cured product of an adhesive.

12. The system according to claim 1, further comprising:
a display apparatus,
wherein the information processing apparatus is configured to cause the display apparatus to display an image corresponding to a search status based on the data set.

13. The system according to claim 1, further comprising:
a display apparatus,
wherein the information processing apparatus configured to cause the display apparatus to display an image indicating the search condition.

14. The system according to claim 2, further comprising:
a display apparatus,
wherein the information processing apparatus configured to cause the display apparatus to display an image indicating a modification candidate of the search condition.

15. The system according to claim 1, wherein the manufactured sample is evaluated by using at least one of a physical property of the sample and a resource required for manufacturing the sample.

16. The system according to claim 5,
wherein the manufacturing condition includes information of a processing condition used in a case of manufacturing the sample, and
wherein the first search setting includes information of a range of the processing condition as the manufacturing condition candidates.

17. The system according to claim 12, wherein the search status is a transition history of the evaluation result.

18. The system according to claim 12, wherein the search status is accuracy of the determination process.

19. The system according to claim 12, wherein the search status is a relationship between the manufacturing condition and the evaluation result.

20. The system according to claim 12, wherein the search status is a relationship between a plurality of evaluation results.

21. An information processing apparatus configured to:
execute a plurality of search cycles together with a trial manufacturing apparatus;
receive input of a search condition;
execute a determination process of determining a manufacturing condition of a sample in each of the plurality of search cycles;
cause the trial manufacturing apparatus to, in each of the plurality of search cycles, execute a manufacturing process of manufacturing the sample in accordance with the manufacturing condition, and an evaluation process of evaluating the manufactured sample and outputting an evaluation result;
determine, in the determination process in a first search cycle among the plurality of search cycles, the manufacturing condition for the manufacturing process in the first search cycle by using the search condition and a data set including data obtained in a second search cycle and a search cycle executed before the second search cycle among the plurality of search cycles, the second search cycle being earlier than the first search cycle in an execution order; and
change the search condition for a third search cycle and a search cycle after the third search cycle among the plurality of search cycles, the third search cycle being next to the first search cycle in the execution order.

22. An information processing method for an information processing apparatus configured to execute a plurality of search cycles together with a trial manufacturing apparatus, the information processing method comprising:
receiving input of a search condition;
executing a determination process of determining a manufacturing condition of a sample in each of the plurality of search cycles;
causing the trial manufacturing apparatus to, in each of the plurality of search cycles, execute a manufacturing process of manufacturing the sample in accordance with the manufacturing condition, and an evaluation process of evaluating the manufactured sample and outputting an evaluation result;
determining, in the determination process in a first search cycle among the plurality of search cycles, the manufacturing condition for the manufacturing process in the first search cycle by using the search condition and a data set including data obtained in a second search cycle and a search cycle executed before the second search cycle among the plurality of search cycles, the second search cycle being earlier than the first search cycle in an execution order; and
changing the search condition for a third search cycle and a search cycle after the third search cycle among the plurality of search cycles, the third search cycle being next to the first search cycle in the execution order.

23. A non-transitory computer-readable recording medium storing a program for causing a computer to execute the information processing method according to claim 22.
